(19) United States
(12) Patent Application Publication
(10) Pub. No.: US 2007/0271335 A1
(43) Pub. Date: Nov. 22, 2007

(54) Electronic Conferencing System Latency Feedback

(76) Inventors: James Edward Bostick, Cedar Park, TX (US); Randolph Michael Forlenza, Austin, TX (US); John Paul Kaemmerer, Pflugerville, TX (US); Raghuraman Kalyanaraman, Austin, TX (US); Courtney Joseph Spooner, Hutto, TX (US)

Correspondence Address: IBM CORP (YA);C/O YEE & ASSOCIATES PC, P.O. BOX 802333, DALLAS, TX, 75380, US

(21) Appl. No.: 11/419,062

(22) Filed: May 18, 2006

(51) Int. Cl. G06F 15/16

(52) U.S. Cl. 709/204

(57) ABSTRACT

A computer implemented method, apparatus and computer usable program code for coordinating electronic conferences. A server determines a presentation latency period in a set of attendee computers. A server transmits the presentation latency period to a presenter computer. The server receives screen content update. The server transmits the screen content update to the set of attendee computers.

### BACKGROUND OF THE INVENTION

1. Field of the Invention

The present invention relates generally to a computer implemented method, apparatus, and computer usable program code for coordinating network mediated meetings. More specifically, the present invention relates to achieving synchronization between voice aspects of a presentation with display rendering of a presentation at an attendee computer or at a hypothetical attendee computer representative of a set of attendee computers.

2. Description of the Related Art

In computer networking and telecommunications, packet switching is the now-dominant communications mode. A computer that transmits a file via a packet network, nearly always breaks that file into smaller packets, wherein the network nodes route packets individually over data links. Many other nodes often share such data links, and so occasionally, a packet must contend with traffic from other computer files. This contrasts with the principal other paradigm, circuit switching. Circuit switching establishes a dedicated connection between the two nodes for their exclusive use for the duration of the communication. Network designers use packet switching to optimize the use of the bandwidth available in a network, to minimize the transmission latency, and to increase robustness of communication. A well-known packet switching network is the Internet.

Electronic conferencing uses a packet network to distribute screen content updates of a presentation from a server computer to many attendee computers. Often, a presenter computer controls the server computer over the same packet network. A presenter computer is an authorized client computer that changes views of a presentation as might occur when a presenter transmits a new screen content update to attendee client computers. A person presenter is a person who operates a presenter computer through user interfaces of the presenter computer.

Ordinarily, a presenter uses modern teleconferencing in tandem with electronic conferencing, wherein teleconferencing transmits voice in real-time. Real-time is a delay in voice reception so small that humans do not detect the presence of delay. The presenter may achieve real-time voice delays by calling to a voice conferencing center that circuit switches the voice call to attendee telephone handsets.

A server computer is a computer that supports presentation hosting. Presentation hosting is the process of sending screen content updates of a presentation to attendee computers that are logged into the server computer. Presentation hosting includes receiving screen content updates in an ad hoc manner, and retransmitting or broadcasting the screen content updates to attendee computers.

An attendee computer is a computer that logs in to a server computer for receiving a presentation as a series of screen content updates. The attendee computer receives and coordinates timing aspects of the received presentation with the server computer.

A latency period is a period estimated for delays to render a screen content update. The period estimated may be based on one or more attendee computers providing acknowledgments. The acknowledgment could establish, among other things, a one-way typical delay for packets to the attendee computer.

The acknowledgement could establish a delay to complete a typical transmission reception at an attendee computer. The acknowledgement could establish a delay to complete a typical rendering of a new screen view at an attendee computer. The acknowledgment could establish a composite delay that a server computer calculates based on these delays.

Unfortunately, participants or attendees of a meeting use attendee computers that vary in several respects that cause a delay in receiving and rendering screen content updates to vary amongst attendee computers. Delay occurs when an attendee computer is distant relative to the server computer. Distance is the number of hops that a typical screen content update packet crosses on the way to an attendee computer. A hop is a direct connection between two nodes of the packet network. That is, two routers share a data link between them, wherein the data link is the hop. Distance delay is a delay that corresponds with distance.

Delay occurs when an attendee computer multitasks programs in addition to programs dedicated to supporting the electronic conferencing programs. Such a delay may vary, even for an attendee's session with the server computer, when the attendee starts and stops programs during the presentation. Multitask delay is a delay that results from a limitation of local computer resources allocated to render a screen content update. Multitask delay is necessarily influenced by hardware delays inherent to the attendee computer. For example, the type of graphics processor and video memory accessed by the graphics processor can change how quickly the attendee computer refreshes the screen.

Attendees further complicate delay by using different interconnect technologies to access a packet network, such as the internet. Some attendees may choose a dial-up connection. Others may prefer to use digital subscriber lines (DSL). Still others may use fiber optic connections. In spite of such varying connection modes, local conditions on a local area network may impact even the higher speed internet interconnects. For example, an attendee on a home network will see a reduction in performance of a fiber optic interconnect if another user on the home network is streaming high definition video using that same fiber. Last-mile delay is a delay that corresponds with bottlenecks of the attendee's Internet service provider interconnect.

Composite delay is the combined effects of distance delay, multitask delay and last-mile delay.

A presenting person suffers from a lack of awareness of what the attendees see from the presentation. This obliviousness is a consequence of the varying delays occurring within and to each attendee computer. Nevertheless, the delay in the presenting person's voice arrives in real-time, causing a disconnect between an attendee hearing the presentation, and seeing the presentation as rendered to the attendee computer.

### SUMMARY OF THE INVENTION

The present invention provides a computer implemented method, apparatus and computer usable program code for coordinating electronic conferences. A server determines a presentation latency period in a set of attendee computers. A server transmits the presentation latency period to a presenter computer. The server receives screen content update. The server transmits the screen content update to the set of attendee computers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a data processing system in accordance with an illustrative embodiment;

FIG. 2 is a block diagram of a data processing system in accordance with an illustrative embodiment;

FIG. 3 is a network diagram of a data processing environment in accordance with an illustrative embodiment;

FIG. 4 is a sequence of displayed screen content updates in accordance with an illustrative embodiment;

FIG. 5 is another sequence of displayed screen content updates in accordance with an illustrative embodiment;

FIG. 6 is yet another sequence of displayed screen content updates in accordance with an illustrative embodiment;

FIG. 7A is a flowchart of steps executed on a server in accordance with an illustrative embodiment;

FIG. 7B is a flowchart of steps executed on a presenter computer in accordance with an illustrative embodiment;

FIG. 8 is an alternate flowchart of steps executed on a server in accordance with an illustrative embodiment;

FIG. 9A is a flowchart of steps executed on an attendee computer in accordance with an illustrative embodiment;

FIG. 9B is a flowchart of steps executed on a presenter computer in accordance with an illustrative embodiment;

FIG. 10A is a flowchart of steps executed on a presenter computer in accordance with an illustrative embodiment; and

FIG. 10B is a flowchart of steps executed on a server computer in accordance with an illustrative embodiment.

### DETAILED DESCRIPTION OF THE PREFERRED EMBODIMENT

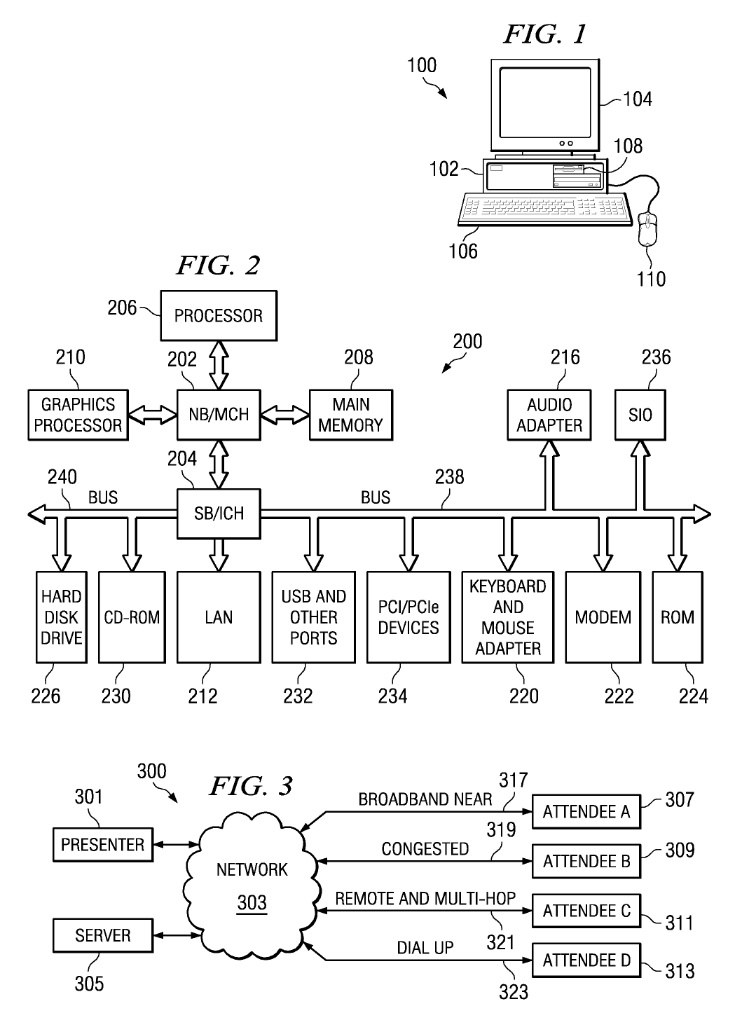

With reference now to the figures and in particular with reference to FIG. 1, a pictorial representation shows a data processing system in which the aspects of the illustrative embodiments may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of an illustrative embodiment may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (NB/MCH) 202 and a south bridge and input/output (I/O) controller hub (SB/ICH) 204. Processor 206, main memory 208, and graphics processor 210 are connected to north bridge and memory controller hub 202. Graphics processor 210 may be connected to the NB/MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

An operating system runs on processor 206 and coordinates and provides control of various components within data processing system 200 in FIG. 2. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 200. Java™ is a trademark of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the illustrative embodiments provide a computer implemented method, apparatus and computer usable program code for managing the speeds at which a presentation changes views. Latency information for attendee computers that attend an electronic conference is collected. The attendee computers may be at varying distances and using varying data processing systems having varying workloads. Once latency information is collected from a set of attendee computers, a server may identify a presentation latency period. The server sends the presentation latency period to a presenter computer so that the presenter computer may feedback to a user/presenter a delay that represents delays inherent in the collective network of attendees and delays inherent in the processing power available to attendees.

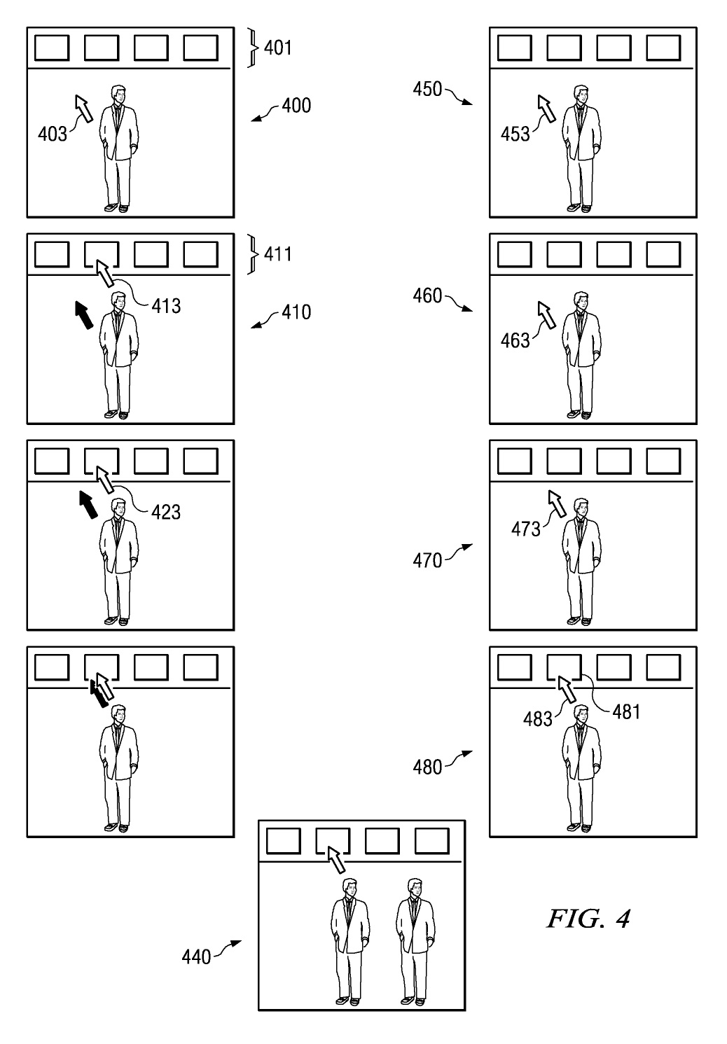

FIG. 3 is a network diagram of a data processing environment in accordance with an illustrative embodiment. Presenter 301 or presenter computer logs in to server 305 or server computer. Presenter 301 and server 305 may each be instances of, for example, data processing system 100 of FIG. 1. A set of attendees also logs in to server 305 wherein each attendee transmits a login. Attendees, presenter 301, and server 305 connect via network 303, which may be, in part, the Internet.

Each attendee operates according to varying connection speeds and circumstances. Attendee A 307 uses broadband connection 317 and is relatively nearby to server 301 in relation to the number of hops needed to reach server 301. Attendee B 309 operates through congested network 319. Attendee C 311 is remote to server 301 as compared to attendee A 307. Attendee C 311 requires many hops 321 for a typical packet to be exchanged between attendee C 311 and server 305. Attendee D 313 connects via dial-up connection 323, which may have the lowest throughput of all attendees. Consequently, attendee D 313 may have a composite delay wherein the communication latency contributes most to the delay as compared to peer attendees.

A presentation latency period is a period determined by an algorithm to establish a tolerable delay to feedback to a presenter computer in order to improve presenter awareness. The presentation latency may be, for example, the average of composite delays to all attendee computers, wherein each composite delay is based on a server receiving acknowledgments from each attendee computer. The illustrative examples of the present invention ensure that selected attendee computers have presented the page or view before allowing the page or view to change.

As an average, the presentation latency period operates as a model whereby some attendees suffer a composite delay worse than the presentation latency period. On the other hand, some attendees, for example, attendee A 307 of FIG. 3, benefit from superior interconnect and better delays than the presentation latency period. Consequently, the model that includes a presentation latency period operates to establish a hypothetical attendee, which is representative of the group of attendees.

FIG. 4 is a sequence of displayed screen content updates in accordance with an illustrative embodiment. On the left, is a fully rendered screen content on a presenter computer, for example, presenter 301 of FIG. 3.

Screen content is the details of a video display presented to a graphics adapter, for example, graphics adapter 210 of FIG. 2. The screen content, once rendered to a screen includes material shown to at least a portion of a screen, for example within the confines of a frame or window. A screen content update is one or more of several files or streams. Such files include data for transitions from one slide to another, data for animations on a display, and data for playback of pre-recorded audio. Because a computer typically sends a file via a packet network, one or more such files may be sent contemporaneously or in sequence. An attendee computer completely receives files that make up a screen content update when the attendee computer receives a final packet from the last file. In this example, thumbnails 401 appear at the top of presenter first rendition 400. A hypothetical attendee shows attendee first rendition 450, which, for the first time period, is a copy of presenter first rendition 400. Attendee is, for example, attendee A 307 of FIG. 3. Attendee first rendition 450 is a view the attendee may present or render after the attendee transmits a login to a server. A login is a received signal from a computer wherein the computer provides communication parameters in the signal that are accepted by a server computer. In addition, the presenter or a host computer may calculate a presentation latency period during or after an attendee logging in.

Presenter first rendition 400 has cursor 403. Attendee first rendition 450 has cursor 453 positioned in the same place relative attendee first rendition 450 as cursor 403 is to presenter first rendition 400.

In a second time period, presenter second rendition 410 and attendee second rendition 460 diverge. During the second time period, a presenter prepares a new screen content update by moving presenter cursor 413 toward thumbnails 411. The new screen content update may comprise a sequence of commands, for example, instructions for moving a cursor as well as instructions concerning new slides and transitions to be displayed. A distinct event, for example, a screen transition between slides, may mark the conclusion of the new screen content update. The presenter clicks a thumbnail representing a new slide as the final action during the second time period. Presenter second rendition 410 is the displayed image in the presenter computer.

In the second time period, the attendee computer displays attendee second rendition 460 at the time the presenter clicks the presenter's mouse. A stream of instructions may be arriving at the attendee computer, wherein the instructions instruct the attendee computer to move the cursor. Because of delays, attendee second cursor 463 lags behind movement of presenter cursor 413. Nevertheless, the attendee computer begins rendering aspects of a screen content update. The rendering continues even though the reception of the screen content update remains a work-in-progress. The attendee computer that renders the screen content update may be, for example, attendee computer A 307 of FIG. 3.

In the third time period in these examples, the presenter computer may suppress moving the cursor in response to the person presenter's attempts to move person presenter's mouse. Cursor 423 remains in the same relative position as cursor 413 of the prior period.

In a third time period, the attendee computer continues to respond to a streamed or otherwise transmitted screen content update. The attendee computer moves cursor 473 closer to a thumbnail within attendee third rendition 470.

In a fourth time period, the presenter computer may continue suppressing cursor movement. The attendee computer receives a final cursor movement instruction and renders attendee fourth rendition 480 wherein cursor 483 is over thumbnail 481. At the conclusion of the fourth time period, the attendee computer may be receiving data concerning the new slide.

According to a time feedback mechanism disclosed below, during a fifth time period, both the presenter computer and the attendee computer render the final instructions of a screen content update. The presenter computer and the attendee computer render resultant rendition 440 to their respective displays. An embodiment may model a hypothetical attendee by setting a presentation latency period to the worst delays among a set of attendee computers. The modeled attendee or hypothetical attendee, for such an embodiment, permits a presenter to render nearly simultaneously with the worst-case attendee with respect to a screen content update.

In the foregoing embodiment, the presenter computer achieves feedback by pausing rendering at key stages of rendering the screen content update.

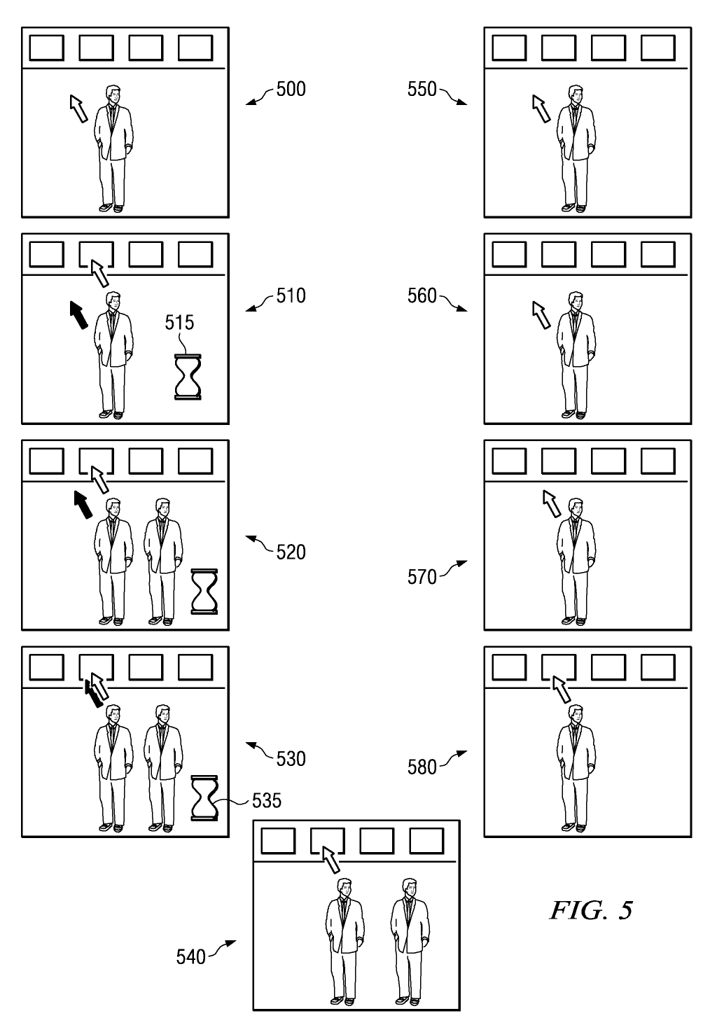

FIG. 5 is another sequence of displayed screen content updates in accordance with an illustrative embodiment. Like the sequence of FIG. 4, the presenter or host computer operating in FIG. 5 may establish a presentation latency period before or during logging in.

A first time period involves the presenter displaying a presenter first rendition 500 and the hypothetical attendee displaying an attendee first rendition 550.

A second time period shows the time shortly after a person presenter clicks his mouse on a thumbnail, wherein the presenter presents presenter second rendition 510. The presenter also presents a delay notice in the form of icon 515. A presenter or host computer generates a screen content update having a delay notice based on a presentation latency period. A presenter may display presenter second rendition 510 responsive to generating the screen content update. A delay notice is a set of computer instructions that instruct an audio adapter or a graphics processor to show or otherwise present a visible or audible alert signaling a delay, for example, instructions for a pop-up window. The attendee displays attendee second rendition 560.

A third time period shows the presenter computer displaying presenter third rendition 520. At this time, the presenter has completed the slide transition. The attendee continues to move a cursor while displaying attendee third rendition 570.

A fourth time period shows the presenter displaying presenter fourth rendition 530. The attendee continues to move a cursor while displaying attendee fourth rendition 580.

A fifth time period shows a time where the presenter and hypothetical attendee displays are synchronized. The presenter computer and the attendee computer render resultant rendition 540 to their respective displays. The presenter executes instructions to inhibit icon 535 that was formerly displayed in the fourth time period.

In the foregoing embodiment, the presenter achieves a delay notice or feedback by showing icon 515 during any significant delay. The presenter continues to display, or fails to inhibit the display of an icon through third time period 520 and fourth time period 530. It is appreciated that pop-up windows may have various shapes and sizes. In addition, the pop-up window may bear a legend that estimates the number of attendees that are in the process of catching up.

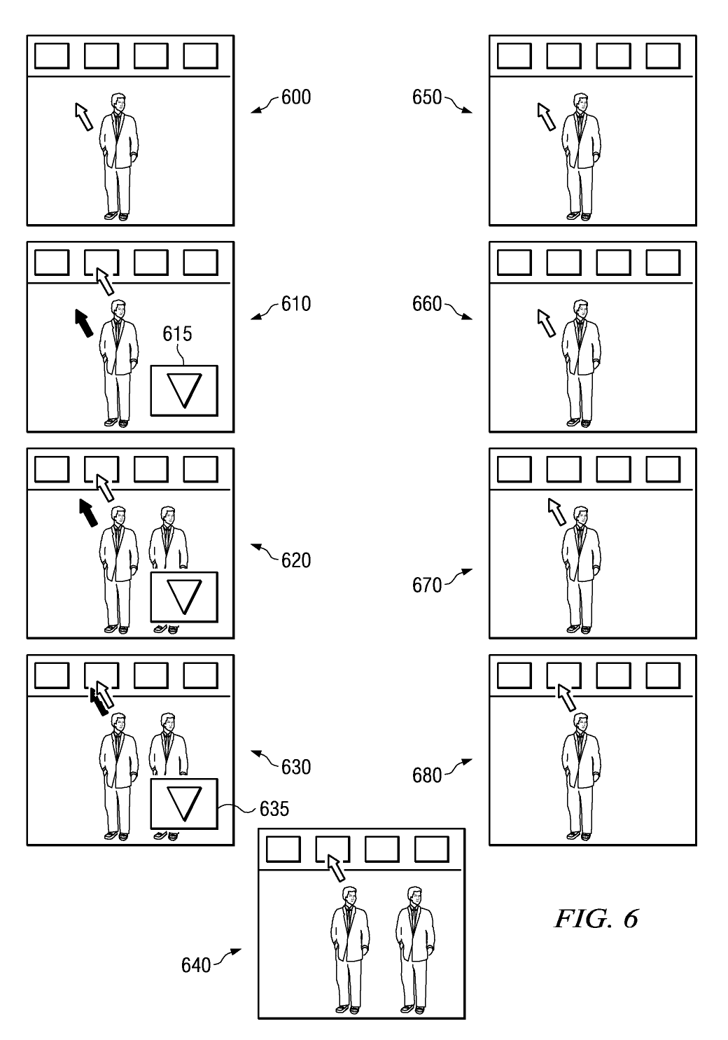

FIG. 6 is yet another sequence of displayed screen content updates in accordance with an illustrative embodiment.

A first time period involves the presenter displaying a presenter first rendition 600 and the hypothetical attendee displaying an attendee first rendition 650.

A second time period shows the time shortly after a person presenter clicks his mouse on a thumbnail, wherein presenter presents presenter second rendition 610. The presenter also presents a delay notice in the form of pop-up 615. A delay notice is a set of computer instructions that instruct an audio adapter or a graphics processor to show or otherwise present a visible or audible alert signaling a delay, for example, instructions to present a pop-up window. The attendee displays attendee second rendition 660.

A third time period shows the presenter displaying presenter third rendition 620. At this time, the presenter has completed the slide transition. The attendee continues to move a cursor while displaying attendee third rendition 670.

A fourth time period shows the presenter displaying presenter fourth rendition 630. The attendee continues to move a cursor while displaying attendee fourth rendition 680.

A fifth time period shows a time where the presenter and hypothetical attendee displays are synchronized. The presenter computer and the attendee computer render resultant rendition 640 to their respective displays. The presenter computer executes instructions to inhibit pop-up 635, wherein the presenter computer formerly displayed the pop-up in the fourth time period.

In the foregoing embodiment, the presenter achieves feedback, for example, by transmitting or otherwise presenting a delay notice. It is appreciated that many other forms of delay indication are contemplated within the scope of the illustrative embodiments, including offering a sound or vibration feedback during any interval that the presenter renders significantly in advance of the hypothetical attendee.

A hypothetical attendee presentation is a presentation having a delay that may vary somewhat from any attendee that has logged in to a presentation. For example, establishing a presentation latency period that results from averaging the first latency period with the second latency period will neither permit showing lag indications corresponding to the first attendee or the second attendee—but rather, will establish a kind of tolerable or reasonable delay, that permits a quicker pacing of presentation. Regrettably, some attendees are slow to get each rendition under an embodiment based on averaging.

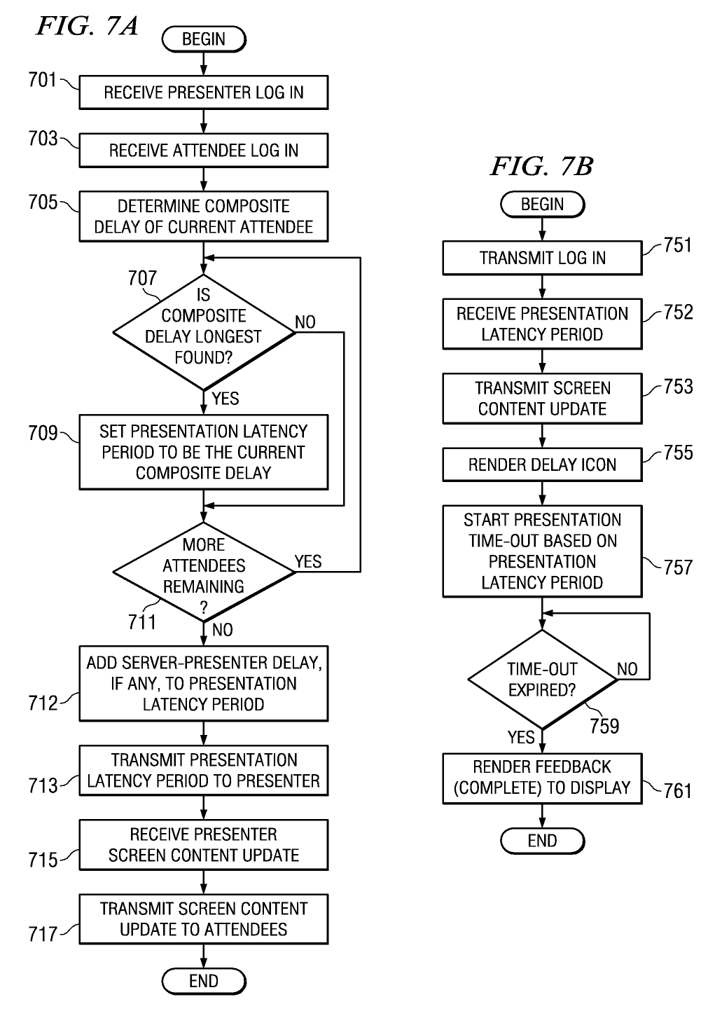

FIG. 7A is a flowchart of steps executed on a server in accordance with an illustrative embodiment. At core, the server receives logins from a presenter and attendees, determines a presentation latency period that will apply to the presentation, and feeds back to the presenter the presentation latency period, wherein the presenter computer is responsible to adjust, and augment rendering to feedback a worst-case delay. The presenter computer is, for example, presenter 301 of FIG. 3. An attendee computer is, for example, any one of attendee A 307, attendee B 309, attendee C 311, and attendee D 313.

The server receives presenter login (step 701). The server is, for example, server 303 of FIG. 3. The server receives attendee login (step 703). An attendee login is a login transmitted by an attendee computer. Receiving may also include the step of authenticating. Once a single attendee is accepted as logged in, that attendee forms a set of attendees. As new attendees login, such attendees are added to the set of attendee computers. The server determines a composite delay of a current attendee (step 705). The server determines if the composite delay is the longest found composite delay (step 707). If so, the server sets the presentation latency period to be the composite delay of the current attendee (step 709). The server may use the new setting of the presentation latency period to operate as a way to judge if a current composite delay is shorter or longer than delays already considered. The server determines if additional attendees remain in the set (step 711). If more attendees remain, server re-executes 707.

The server may add a server-presenter delay, if any, to the presentation latency period (step 712). A server-presenter delay is an estimation of time that a typical packet may spend in transit between the server and the presenter computers. For reasons of transient congestion in a network, the actual time some packets spend in transit may vary somewhat from the estimation.

Once no attendees remain, the server transmits the presentation latency period to the presenter computer (step 713). The presenter begins the presenter's presentation. The server receives a screen content update (step 715). The server transmits the screen content update to the set of attendees (step 717).

FIG. 7B is a flowchart of a presenter illustrative embodiment that corresponds with the server illustrative embodiment shown in FIG. 7A. The presenter is, for example, presenter 301 of FIG. 3. The presenter transmits a login to the server (step 751). The presenter receives a presentation latency period (step 752). The latency period corresponds to the presentation latency period the server transmits at step 713 of FIG. 7A.

The presenter transmits a screen content update (step 753). The presenter renders a delay icon (step 755). As may be appreciated, creating a background tone, or producing a pop-up may be performed as alternatives to step 755. The presenter starts a presentation time-out based on the presentation latency period (step 757). The presenter determines whether the time-out has expired (step 759). A time-out is a counter or another electronic time measurement that triggers an event upon conclusion. A process operating on a computer may start a time-out and expire a time-out. A positive determination to step 759 is an example of expiring a time-out. A negative determination returns the presenter to the execute step 759.

A positive determination to step 759 leads the presenter to render feedback to a display (step 761). The feedback rendered may be removing an icon or pop-up or otherwise signaling with user output that the presentation latency period has concluded. Additional screen content updates may be transmitted by continuing execution at step 753, otherwise, the process may terminate thereafter.

FIG. 8 is an alternate flowchart of steps executed on a server in accordance with an illustrative embodiment. Server 301 of FIG. 3 may perform the steps shown. The server receives a presenter login (step 801). The server receives an attendee login (step 803). The server receives a presenter selected subset of attendees (805). Step 805 permits a person presenter, through a presenter computer to establish a selected set of attendee computers. The selected set of attendee computers is a set of computers that a person presenter picks or otherwise selects through the use, for example, of a keyboard and mouse, for example, using keyboard and mouse adapter 220 of FIG. 2. Through the keyboard and mouse adapter, presenter receives the selected set of attendee computers.

An alternative manner to obtain a selected set of attendee computers is to establish a cut-off time. This illustrative embodiment of the present invention may permit the presenter to reach a preferred time and cut-off consideration of further attendees. This illustrative embodiment may permit the presenter to cherry pick the presenter's favored attendees, and account only for them. For example, this may permit a presenter to ignore known laggard attendees.

Still a further alternative manner to obtain a selected set of attendee computers is for a person presenter to pick which attendees the person presenter would like to exclude from an accounting of delays. Such an arrangement would suit situations where most attendee computers operate with good quality of service and minimize delays, whereas a minority of attendee computers is sluggish.

The server determines a composite delay for a current attendee (step 807). The server determines whether more attendees remain in the subset of attendees (808). The subset of attendees is a set of attendee computers. If more attendees remain in the subset, the server continues with step 807. Otherwise, the server determines delays of the set of attendees to obtain a presentation latency period (step 809). The server may reduce the presentation latency period by a server-presenter delay, if any (step 811). The server receives a presenter screen content update (step 813). The server transmits the screen content update to all attendees that have logged in (step 815). The server may transmit feedback to the presenter (step 817). The feedback may merely be a pop-up or icon as described with relation to FIG. 5 and FIG. 6.

The server may determine the presentation latency period by selecting a worst-case among the latencies of each attendee in the subset. The server may determine the presentation latency period by averaging the latencies of all attendees in the subset. If the set is a single attendee, then both methods yield the same presentation latency period.

The server starts a presentation time-out based on the presentation latency period (step 819). The server determines if the time-out has expired (step 821). If the time-out has not expired, the server continues determining step 821. Upon an affirmative determination, the server transmits or otherwise feeds back completion to the presenter (step 823). Step 823 may involve transmitting a file that includes computer instructions to remove or inhibit an existing delay notice that appears on presenter's display. Consequently, step 823 may also be referred to as inhibiting a delay notice. Presenter is, for example, presenter 301 of FIG. 3.

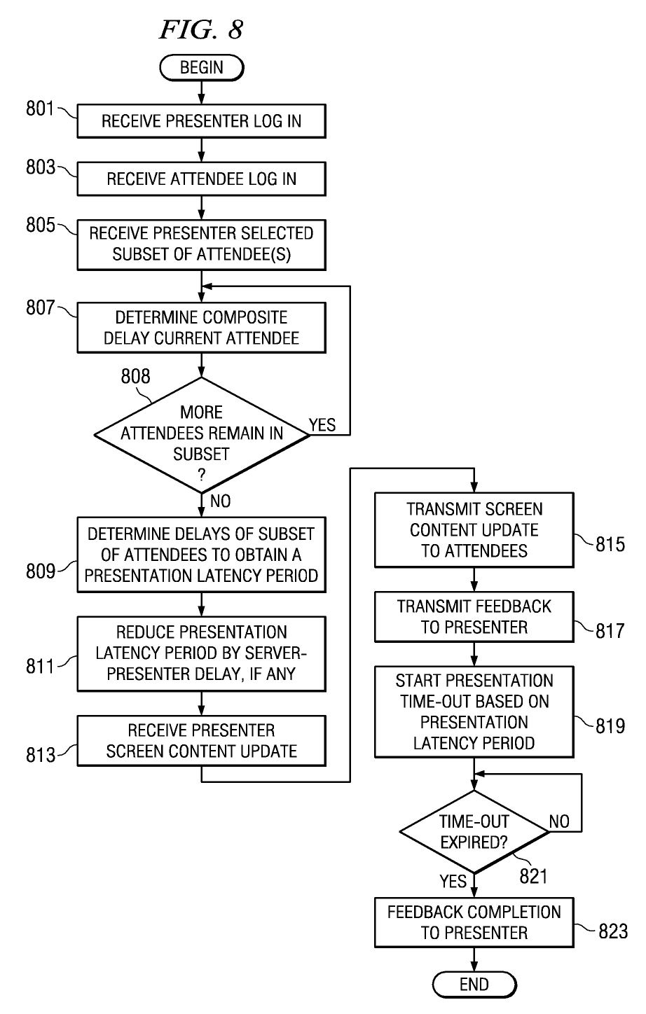

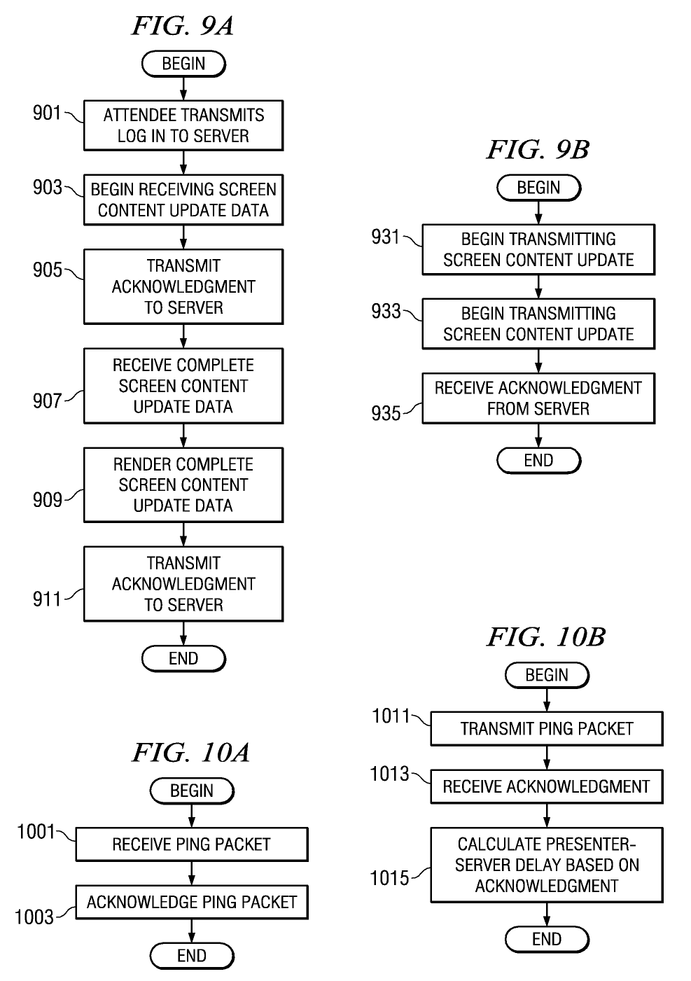

FIG. 9A is a flowchart of steps executed on an attendee in accordance with an illustrative embodiment. The attendee provides details that permit estimation of network and local computing resource delays. The attendee may be, for example, attendee A 307 of FIG. 3, or any other attendee therein. The attendee transmits a login to the server (step 901). The attendee will periodically transmit or receive information from the server or presenter. The attendee is receiving a presentation during this time, although the transmittals may be intermittent. Receiving the presentation continues until the attendee logs out. The server may be, for example, server 301 of FIG. 3. The attendee begins receiving a screen content update data (step 903). The screen content update data may merely be a test that includes representative rendering instructions. The attendee transmits an acknowledgement to the server (step 905). The attendee receives the complete screen content update data (step 907). The attendee renders the complete screen content update (step 909). The attendee transmits a second acknowledgment to server (step 911).

Alternatively, the attendee may simulate rendering and provide an acknowledgment based on the simulation. Yet another alternative includes estimating a duration for rendering a complete screen content update based on a formula. Thus, instead of step 911, the attendee may transmit a rendering delay to server, wherein the server may incorporate the rendering delay into a composite latency for the attendee.

FIG. 9B is a flowchart of steps executed on a server computer in accordance with an illustrative embodiment and corresponds with steps in FIG. 9A. A server begins transmitting screen content update data to an attendee (step 931). The server receives an acknowledgement from the attendee (step 933). The server may calculate the one-way trip time to be half the difference between beginning transmitting and receiving the acknowledgement.

The server receives a second acknowledgement from the attendee (step 935). The second acknowledgement confirms that the attendee completed rendering the current or latest screen content update. The server may calculate a composite delay based on these two acknowledgements. The composite delay is the interval between step 931 and step 935, minus half the interval between step 931 and 933. The composite delay is the estimated duration between the beginning of sending the screen content update, and actual visibility of the screen content update on the particular attendee. The process terminates thereafter.

FIG. 10A is a flowchart of steps executed on a presenter computer in accordance with an illustrative embodiment. The presenter computer may be presenter 301 of FIG. 3. The presenter computer receives a ping packet from the server (step 1001). The server is, for example, server 303 of FIG. 3. The presenter acknowledges the ping packet (step 1003). The presenter acknowledges by sending a packet back to the server. The process terminates thereafter.

FIG. 10B is a flowchart of steps executed on a server computer in accordance with an illustrative embodiment. In this example, the server computer is able to estimate a presenter-server delay. The server is, for example, server 303 of FIG. 3.

The server transmits a ping packet to the presenter (step 1011). The server receives a ping packet from the presenter (step 1013). The server calculates the presenter-server delay based on the acknowledgment (step 1015). The server may simply compare times for the outbound ping and the returned acknowledgment and establish the presenter-server delay to be half the round trip time for the acknowledgment to be returned. The process terminates thereafter. The process of FIG. 10B may be executed in support of steps 712 and 811 of FIG. 7A and FIG. 8 respectively. These steps modify a presentation latency period based on the server-presenter delay, if any.

Presentation latency period may be established based on several methods. First, averaging. Second, based on a selected attendee composite delay, wherein the selected attendee may have the longest composite delay among the set of attendees.

Thus, illustrative embodiments provide a computer implemented method, apparatus, and computer usable program code for halting presentations or otherwise warning on a presenter computer that corresponds in an electronic conference.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for coordinating electronic conferences comprising:
determining a presentation latency period for a presentation being received by a set of attendee computers; and
generating a screen content update having a delay notice, based on the presentation latency period.

2. The computer implemented method of claim 1 further comprising:
transmitting the presentation latency period to a presenter computer;
receiving a second screen content update; and
reducing the presentation latency period based on a server-presenter delay.

3. The computer implemented method of claim 1 further comprising:
transmitting the delay notice.

4. The computer implemented method of claim 1 further comprising:
expiring a time-out.

5. The computer implemented method of claim 4 further comprising:
inhibiting the delay notice.

6. The computer implemented method of claim 1 wherein the presentation latency period is an average of a set of attendee computers.

7. The computer implemented method of claim 1 wherein the presentation latency period is a longest composite delay among the set of attendee computers.

8. The computer implemented method of claim 7 further comprising:
receiving a selected set of attendee computers, wherein the set of attendee computers is the selected set of attendee computers.

9. A computer program product comprising a computer usable medium having computer usable program code for coordinating electronic conferences, said computer program product including;
computer usable program code for determining a presentation latency period for a presentation being received by a set of attendee computers; and
computer usable program code for generating a screen content update having a delay notice, based on the presentation latency period.

10. The computer program product of claim 9 further comprising:
computer usable program code for transmitting the presentation latency period to a presenter computer;
computer usable program code for receiving a second screen content update; and
computer usable program code for reducing the presentation latency period based on a server-presenter delay.

11. The computer program product of claim 9 further comprising:
computer usable program code for transmitting a delay notice.

12. The computer program product of claim 9 further comprising:
computer usable program code for expiring a time-out.

13. The computer program product of claim 12 further comprising:
computer usable program code for inhibiting a delay notice.

14. The computer program product of claim 9, wherein the presentation latency period is an average of a set of attendee computers.

15. The computer program product of claim 9, wherein the presentation latency period is a longest composite delay among the set of attendee computers.

16. A data processing system comprising:
a bus;
a storage device connected to the bus, wherein computer usable code is located in the storage device;
a communication unit connected to the bus;
a processing unit connected to the bus, wherein the processing unit executes the computer usable code to coordinate electronic conferences, the processing unit further executes the computer usable code to determine a presentation latency period for a presentation being received by a set of attendee computers; and generate a screen content update having a delay notice, based on the presentation latency period.

17. The data processing system of claim 16 wherein the processing unit further executes the computer usable code to transmit the presentation latency period to a presenter computer; receive a second screen content update; and reduce the presentation latency period based on a server-presenter delay.

18. The data processing system of claim 16 wherein the processing unit further executes the computer usable code to: transmit a delay notice.

19. The data processing system of claim 16 wherein the processing unit further executes the computer usable code to expire a time-out.

20. The data processing system of claim 19 wherein the processing unit further executes the computer usable code to inhibit a delay notice.
